(19) United States
(12) Patent Application Publication
(10) Pub. No.: US 2026/0307679 A1
(43) Pub. Date: Oct. 8, 2026

(54) SYSTEM AND METHOD FOR GENERATING CAUTION ZONE DATA IN PATH

(71) Applicant: INAVI SYSTEMS CORPORATION, Seongnam-si, Gyeonggi-do (KR)

(72) Inventors: Han Soo JUNG, Anyang-si (KR); Da El CHOI, Gunpo-Si (KR)

(73) Assignee: INAVI SYSTEMS CORPORATION, Seongnam-si, Gyeonggi-do (KR)

(21) Appl. No.: 19/482,915

(22) PCT Filed: May 3, 2024
(86) PCT No.: PCT/KR2024/005993

§ 371 Date: Nov. 10, 2025

(30) Foreign Application Priority Data
May 10, 2023 (KR) 10-2023-006019

(51) Int. Cl. B60W 60/00

(52) U.S. Cl. CPC B60W 60/0015; B60W 2552/53; B60W 2555/60

(57) ABSTRACT

Disclosed are a system and a method for generating caution zone data in a path. The system for generating caution zone data in a path according to the present invention comprises: a trajectory information generation unit for generating trajectory information including link groups composed of links connecting a plurality of nodes on the path to a destination of an autonomous vehicle; and caution zone data generation unit for generating caution zone data by matching a link group of a zone in which the autonomous vehicle is required to exercise caution when traveling among the link groups included in the trajectory information.

### TECHNICAL FIELD

The disclosure relates to a system and method for generating caution zone data in a path and to a system and method for generating caution zone data in a path, which can help an autonomous vehicle to safely travel by providing information on a precise location of a caution zone matched with information on the trajectory along which the autonomous vehicle travels to a destination in a way to generate the trajectory information including a link group having links that connect a plurality of nodes in a path up to the destination of the autonomous vehicle and to generate caution zone data by matching a link group of a zone that requires attention when the autonomous vehicle travels, among link groups included in the trajectory information.

### BACKGROUND ART

Point to point (P2P) autonomous driving refers to a technique in which an autonomous vehicle autonomously travels up to a destination when the destination is determined. In the P2P autonomous driving, a high definition (HD) map is used to generate a trajectory up to a destination.

The HD map refers to a map for providing an autonomous vehicle with information on detailed roads and surrounding geographical features in advance. The HD map has accuracy of a level within an error range of 10 cm, and includes information, such as traffic lights, signs, curbstones, road markings, and various structures, in addition to information in a lane unit, such as the centerline of a road and a borderline, in a three-dimensional digital form.

The HD map is an essential element for safe autonomous driving. The reason why the HD map is required is that in a decision-making process for autonomous driving, the HD map helps detailed information of the HD map to be correctly determined. In order for a vehicle itself, rather than a human driver, to take full responsibility for driving, it is necessary to sufficiently provide the vehicle with information regarding the driving environment.

However, a current HD map has difficulties in implementing safe autonomous driving because several types of information are mixed along with information necessary for safety. For example, when information on a crosswalk is required, the HD map also includes other road markings, such as arrows, in addition to the crosswalk on the road, which makes it inefficient for a vehicle to extract only crosswalk information.

Furthermore, the current HD map causes inefficiency because all types of information on traffic lights, including those unrelated to a path along which a vehicle travels, are included in the HD map when information on the traffic lights is required. Furthermore, there is a problem in that a vehicle may pass through such stop lines without stopping because the HD map does not include information on stop lines in which traffic lights are not present.

### DISCLOSURE

### Technical Problem

An object of the present disclosure is to provide a system and method for generating caution zone data in a path and to a system and method for generating caution zone data in a path, which can help an autonomous vehicle to safely travel by providing information on a precise location of a caution zone matched with information on the trajectory along which the autonomous vehicle travels to a destination in a way to generate the trajectory information including a link group having links that connect a plurality of nodes in a path up to the destination of the autonomous vehicle and to generate caution zone data by matching a link group of a zone that requires attention when the autonomous vehicle travels, among link groups included in the trajectory information.

Objects of the present disclosure are not limited to the aforementioned object, and other objects not described above may be evidently understood by those skilled in the art from the following description.

### Technical Solution

A system for generating caution zone data in a path according to an embodiment of the present disclosure comprises a trajectory information generation unit configured to generate trajectory information containing a link group composed of links that connect a plurality of nodes in a path up to the destination of an autonomous vehicle, and a caution zone data generation unit configured to generate caution zone data by matching a link group of a zone that requires attention when the autonomous vehicle travels, among link groups included in the trajectory information.

The caution zone data generation unit may generate the caution zone data matched with a corresponding link group when a link group corresponding to an intersection is present in link groups included in the trajectory information.

The caution zone data may include one or more data, among estimated vehicle-joining section data, crosswalk data, traffic lights data, and stop line section data in which traffic lights are not present.

The caution zone data generation unit may search for a link group that is connected to a link group in a direction to proceed after the intersection, and may generate estimated vehicle-joining section data based on node information of links belonging to the retrieved link group.

The caution zone data generation unit may generate crosswalk data by extracting crosswalk information matched with the intersection.

The caution zone data generation unit may generate stop line section data in which traffic lights are not present by extracting nodes ToNode of the link end point of a link group right before the intersection when traffic lights information matched with the intersection is not present.

The caution zone data generation unit may generate traffic lights data by extracting traffic lights information matched with the intersection.

A method of generating caution zone data in a path according to an embodiment of the present disclosure may include a trajectory information generation step of generating, by a trajectory information generation unit, trajectory information including a link group including links that connect a plurality of nodes in a path up to the destination of an autonomous vehicle, and a caution zone data generation step of generating, by a caution zone data generation unit, caution zone data by matching a link group of a zone that requires attention when the autonomous vehicle travels, among link groups included in the trajectory information.

The caution zone data generation step may include a step of generating, by the caution zone data generation unit, caution zone data matched with a corresponding link group when the link group corresponding to an intersection is present in link groups included in the trajectory information.

The caution zone data may include one or more data, among estimated vehicle-joining section data, crosswalk data, traffic lights data, and stop line section data in which traffic lights are not present.

### Advantageous Effects

According to an aspect of the present disclosure, there can be provided the system and method for generating caution zone data in a path and to a system and method for generating caution zone data in a path, which can help an autonomous vehicle to safely travel by providing information on a precise location of a caution zone matched with information on the trajectory along which the autonomous vehicle travels to a destination in a way to generate the trajectory information including a link group having links that connect a plurality of nodes in a path up to the destination of the autonomous vehicle and to generate caution zone data by matching a link group of a zone that requires attention when the autonomous vehicle travels, among link groups included in the trajectory information.

The system and method for generating caution zone data in a path according to an embodiment of the present disclosure can prevent an accident by previously determining a caution zone in which a vehicle needs to carefully travel while checking the caution zone through a sensor, by providing estimated vehicle-joining section data, crosswalk data, traffic lights data, and stop line section data in which traffic lights are not present as caution zone data.

Furthermore, the system and method for generating caution zone data in a path according to an embodiment of the present disclosure have an effect in that a program speed is improved because only data necessary for a path along which an autonomous vehicle will travel are extracted.

Effects which may be obtained in the present disclosure are not limited to the aforementioned effects, and the other effects not described above may be evidently understood by a person having ordinary knowledge in the art from the following description.

### BRIEF DESCRIPTION OF DRAWINGS

FIG. 1 is a diagram schematically illustrating a system for generating caution zone data in a path according to an embodiment of the present disclosure.

FIGS. 2A and 2B are diagrams that disclose the nodes of an HD map included in trajectory information that is generated by a trajectory information generation unit of the system for generating caution zone data in a path according to an embodiment of the present disclosure.

FIG. 3 is a diagram that discloses the links of an HD map included in trajectory information that is generated by the trajectory information generation unit of the system for generating caution zone data in a path according to an embodiment of the present disclosure.

FIG. 4 is a diagram for describing a process of generating estimated vehicle-joining section data that are generated by a caution zone data generation unit of the system for generating caution zone data in a path according to an embodiment of the present disclosure.

FIG. 5 is a diagram for describing a process of generating crosswalk data that are generated by the caution zone data generation unit of the system for generating caution zone data in a path according to an embodiment of the present disclosure.

FIG. 6 is a diagram for describing a process of generating traffic lights data that are generated by the caution zone data generation unit of the system for generating caution zone data in a path according to an embodiment of the present disclosure.

FIG. 7 is a diagram for describing a process of generating stop line section data in which traffic lights are not present, which are generated by the caution zone data generation unit of the system for generating caution zone data in a path according to an embodiment of the present disclosure.

FIG. 8 is a flowchart for describing a method of generating caution zone data in a path according to an embodiment of the present disclosure.

FIG. 9 is a block diagram illustrating a computer system for implementing a method of generating caution zone data in a path according to an embodiment of the present disclosure.

### MODE FOR INVENTION

The aforementioned object, other objects, advantages, and characteristics of the present disclosure and a method for achieving the objects, advantages, and characteristics will be clearly described through the following embodiments with reference to the accompanying drawings. However, the present disclosure is not limited to embodiments disclosed hereinafter, but may be implemented in various different forms. The embodiments are merely provided to complete the present disclosure and to fully notify a person having ordinary knowledge in the art to which the present disclosure pertains to the category of the present disclosure. The present disclosure is merely defined by the claims. Terms used in this specification are used to describe embodiments and are not intended to limit the present disclosure. In this specification, an expression of the singular number also includes an expression of the plural number unless clearly defined otherwise in the context. The term “comprises” and/or “comprising” used in this specification does not exclude the presence or addition of one or more other components, steps, operations and/or elements in addition to mentioned components, steps, operations and/or elements.

In describing the present disclosure, a detailed description of a related known technology will be omitted if it is deemed to make the subject matter of the present disclosure unnecessarily vague.

Hereinafter, embodiments of the present disclosure are described in detail with reference to the accompanying drawings. In describing the present disclosure, in order to facilitate general understanding of the present disclosure, the same reference numeral is used for the same mean regardless of the reference numeral.

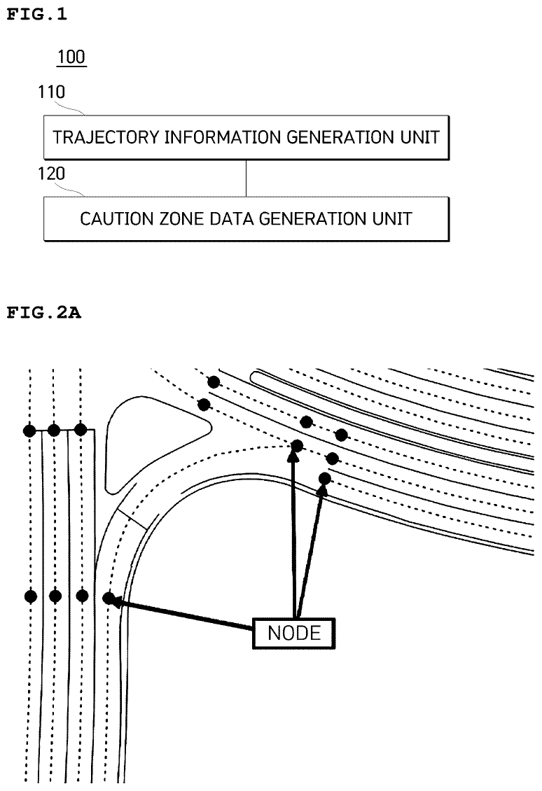

FIG. 1 is a diagram schematically illustrating a system for generating caution zone data in a path according to an embodiment of the present disclosure.

Referring to FIG. 1, a system 100 for generating caution zone data in a path according to an embodiment of the present disclosure includes a trajectory information generation unit 110 and a caution zone data generation unit 120. The system 100 for generating caution zone data in a path, which is illustrated in FIG. 1, is a system according to an embodiment. The components of the system 100 for generating caution zone data in a path according to the present disclosure are not limited to the embodiment illustrated in FIG. 1, and a component may be added to the components or the components may be changed or deleted.

In an embodiment, the system 100 for generating caution zone data in a path according to an embodiment of the present disclosure is mounted on a vehicle, such as an autonomous vehicle, and may generate a point to point (P2P) autonomous driving path by using a high definition (HD) map.

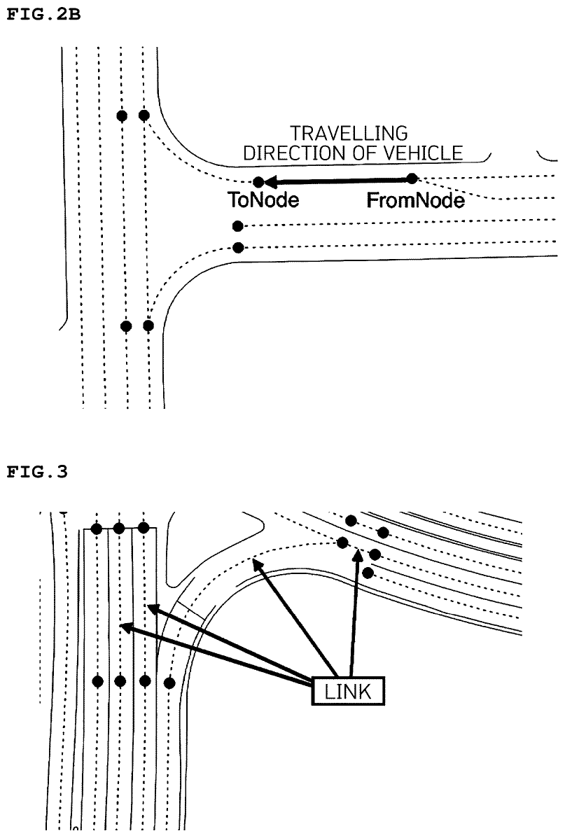

The trajectory information generation unit 110 generates trajectory information including a link group including links that connect a plurality of nodes in a path up to the destination of an autonomous vehicle. In an embodiment, the trajectory information generation unit 110 may generate an autonomous driving path by using both a path generated as a navigation map (SD map) and the centerline of a lane of an HD map. For example, the trajectory information generation unit 110 generates path information for a navigation map up to a destination when the destination of an autonomous vehicle is input, and may generate trajectory information by matching the path information for the navigation map and the link of an HD map. The path information for the navigation map provides guidance to only a road on which a vehicle needs to travel up to a destination, and cannot provide guidance in the lane unit. The trajectory information of the HD map can provide guidance in the lane unit. The trajectory information generation unit 110 can reduce a computational load and rapidly search for an optimal path by first generating path information for a navigation map and generating trajectory information of an HD map, which is matched with the path information. Hereinafter, a node, a link, and a link group included in trajectory information generated by the trajectory information generation unit 110 are described with reference to FIGS. 2 and 3.

FIGS. 2A and 2B are diagrams that disclose the nodes of an HD map included in trajectory information that is generated by a trajectory information generation unit of the system for generating caution zone data in a path according to an embodiment of the present disclosure.

Referring to FIG. 2A, the node included in the trajectory information that is generated by the trajectory information generation unit 110 of the system 100 for generating caution zone data in a path according to an embodiment of the present disclosure is a connection point of a link, and is generated at a point, such as a stop line, an entry/exit time point, a point at which rotation occurs, a start/end point of a tunnel, a bridge, an underground roadway, an overpass, or a tollgate.

FIG. 2B illustrates the node FromNode of the start point of a link and the node ToNode of the end point of the link as the type of node.

FIG. 3 is a diagram that discloses the links of an HD map included in trajectory information that is generated by the trajectory information generation unit of the system for generating caution zone data in a path according to an embodiment of the present disclosure.

Referring to FIG. 3, the link included in the trajectory information that is generated by the trajectory information generation unit 110 of the system 100 for generating caution zone data in a path according to an embodiment of the present disclosure refers to a form in which the link is constructed in the form of a line by considering the direction of progress of a driving path. The link of the driving path must secure connectivity and includes a branch and an intersection. As described above, the trajectory information generation unit 110 needs to match path information generated in the form of a navigation map and several tens of links of an HD map. In order to improve such matching, the concept of a link group may be introduced. When several links are grouped into one link group, fast matching is possible because an arithmetic operation of matching path information with several tens of links of an HD map may be substituted with an arithmetic operation for several groups.

Referring back to FIG. 1, the caution zone data generation unit 120 generates caution zone data by matching a link group of a zone that requires attention, among link groups included in trajectory information when an autonomous vehicle travels. In an embodiment, the caution zone data generation unit 120 may generate caution zone data matched with a corresponding link group when a link group corresponding to an intersection is present in link groups included in trajectory information. When an autonomous vehicle travels, there is a poor possibility that a dangerous situation will happen in the case of a common driving lane section, but there is a good possibility that a dangerous situation will happen in the case of a complicated intersection at which lanes are crossed. Accordingly, when an intersection is present in trajectory information generated by the trajectory information generation unit 110, the caution zone data generation unit 120 may dynamically generate caution zone data at the intersection. A program speed is improved and an accident can be prevented by previously determining a caution zone because the caution zone data generation unit 120 extracts only caution zone data necessary for a path along which an autonomous vehicle will travel as described above.

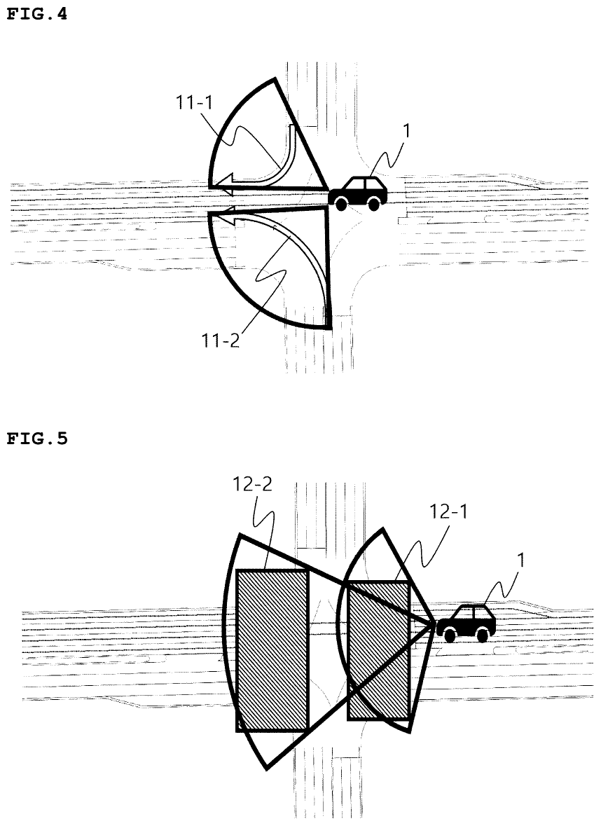

In an embodiment, caution zone data may include one or more data, among estimated vehicle-joining section data, crosswalk data, traffic lights data, and stop line section data in which traffic lights are not present. Information that an autonomous vehicle needs to be most careful about for safe driving at an intersection includes information, such as an estimated vehicle-joining section, a crosswalk, traffic lights, and a stop line. The caution zone data generation unit 120 may generate such information as caution zone data. Hereinafter, a process of the caution zone data generation unit 120 generating each of caution zone data is described with reference to FIGS. 4 to 7.

FIG. 4 is a diagram for describing a process of generating estimated vehicle-joining section data that are generated by the caution zone data generation unit of the system for generating caution zone data in a path according to an embodiment of the present disclosure.

Referring to FIG. 4, the caution zone data generation unit 120 of the system 100 for generating caution zone data in a path according to an embodiment of the present disclosure generates estimated vehicle-joining section data 11-1 and 11-2. Accordingly, a joining point crash accident can be prevented because a section in which another vehicle will be joined in a path along which an autonomous vehicle 1 will travel can be previously checked.

In an embodiment, when the trajectory information generation unit 110 generates trajectory information, the caution zone data generation unit 120 searches for a link group that is connected to a link group in a direction to proceed after an intersection, when a link group corresponding to the intersection is present in link groups included in the trajectory information, and may generate the estimated vehicle-joining section data 11-1 and 11-2 based on node information of links belonging to the retrieved link group. The caution zone data generation unit 120 may generate the estimated vehicle-joining section data 11-1 and 11-2 because a connection of link groups after the intersection may be determined as an estimated vehicle-joining section.

FIG. 5 is a diagram for describing a process of generating crosswalk data that are generated by the caution zone data generation unit of the system for generating caution zone data in a path according to an embodiment of the present disclosure.

Referring to FIG. 5, the caution zone data generation unit 120 of the system 100 for generating caution zone data in a path according to an embodiment of the present disclosure generates crosswalk data 12-1 and 12-, may use the crosswalk data as range information that needs to be checked by an autonomous vehicle through a sensor, and may prepare for a pedestrian crash accident.

In an embodiment, when the trajectory information generation unit 110 generates trajectory information, the caution zone data generation unit 120 may generate the crosswalk data 12-1 and 12-2 by extracting crosswalk information matched with an intersection when a link group corresponding to the intersection is present in link groups included in the trajectory information. When an intersection is present, the section data generation unit 120 may generate the crosswalk data 12-1 and 12-2 by extracting crosswalk information matched with the corresponding intersection because an HD map also includes the crosswalk information on a road.

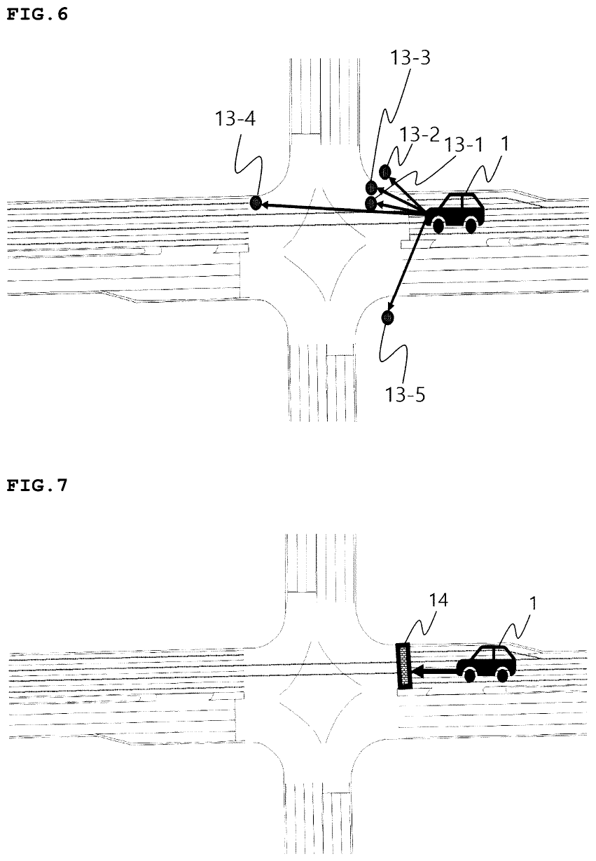

FIG. 6 is a diagram for describing a process of generating traffic lights data that are generated by the caution zone data generation unit of the system for generating caution zone data in a path according to an embodiment of the present disclosure.

Referring to FIG. 6, the caution zone data generation unit 120 of the system 100 for generating caution zone data in a path according to an embodiment of the present disclosure provides an autonomous vehicle with traffic lights location and type information data by generating traffic lights data 13-1 to 13-5, which helps a sensor of the autonomous vehicle to rapidly find the location and type of a signal.

In an embodiment, when the trajectory information generation unit 110 generates trajectory information, the caution zone data generation unit 120 determines whether traffic lights information matched with an intersection is present when a link group corresponding to the intersection is present in link groups included in the trajectory information. In this case, when the traffic lights information matched with the intersection is present, the caution zone data generation unit may generate the traffic lights data 13-1 to 13-5 by extracting the traffic lights information matched with the intersection. When an intersection is present, the section data generation unit 120 may generate the traffic lights data 13-1 to 13-5 by extracting traffic lights information matched with the corresponding intersection because an HD map also includes the traffic lights information.

FIG. 7 is a diagram for describing a process of generating stop line section data in which traffic lights are not present, which are generated by the caution zone data generation unit of the system for generating caution zone data in a path according to an embodiment of the present disclosure.

Referring to FIG. 7, the caution zone data generation unit 120 of the system 100 for generating caution zone data in a path according to an embodiment of the present disclosure generates stop line section data 14 in which traffic lights are not present and provides an autonomous vehicle with an intersection and a stop line section in which traffic lights are not present so that the autonomous vehicle can travel more carefully.

In an embodiment, when the trajectory information generation unit 110 generates trajectory information, the caution zone data generation unit 120 determines whether traffic lights information matched with an intersection is present when a link group corresponding to the intersection is present in link groups included in the trajectory information. In this case, when the traffic lights information matched with the intersection is not present, the caution zone data generation unit may generate the stop line section data 14 in which traffic lights are not present by extracting the nodes ToNode of the link end point of a link group right before the intersection. The section data generation unit 120 may generate the stop line section data 14 in which traffic lights are not present by collecting the nodes ToNode of the link end point of the link group right before the intersection because an HD map does not separately include stop line information.

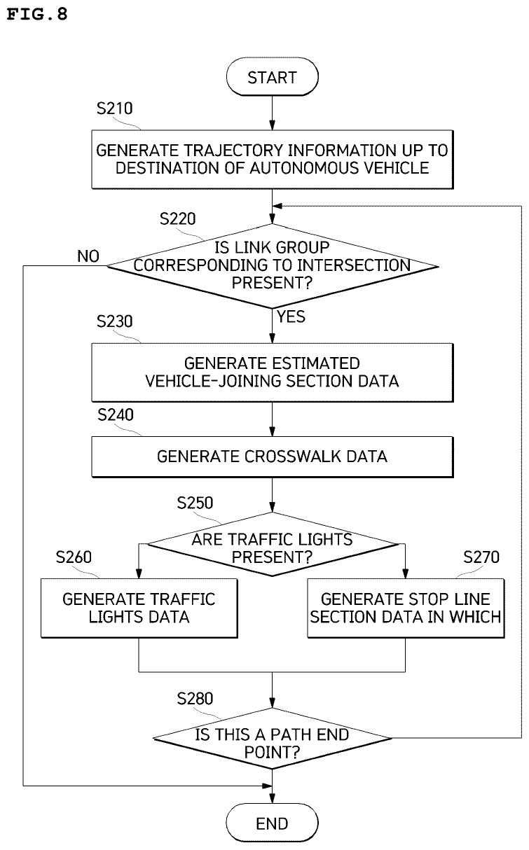

FIG. 8 is a flowchart for describing a method of generating caution zone data in a path according to an embodiment of the present disclosure.

As illustrated in FIG. 8, the method of generating and extracting caution zone data in a path according to an embodiment of the present disclosure may include step S210 to step S280.

Step S210 is a trajectory information generation step of generating, by the trajectory information generation unit 110, trajectory information including a link group composed of links that connect a plurality of nodes in a path up to the destination of an autonomous vehicle.

Steps S220 to S280 correspond to a caution zone data generation step of generating, by the caution zone data generation unit 120, caution zone data by matching a link group of a zone that requires attention when the autonomous vehicle travels, among link groups included the trajectory information.

In the caution zone data generation step, first, the caution zone data generation unit determines whether a link group corresponding to an intersection is present in link groups included in the trajectory information (S220). Furthermore, when the link group corresponding to the intersection is present in the link groups included in the trajectory information, the caution zone data generation unit generates caution zone data matched with the corresponding link group (S230 to S270).

In this case, the caution zone data generation unit 120 searches for a link group that is connected to a link group in a direction after the intersection, generates estimated vehicle-joining section data (S230) based on node information of links belonging to the retrieved link group, generates crosswalk data (S240) by extracting crosswalk information matched with the intersection, determines whether traffic lights information matched with the intersection is present (S250), generates traffic lights data (S260) by extracting the traffic lights information matched with the intersection when the traffic lights information matched with the intersection is present, and generates stop line section data in which traffic lights are not present (S270) by extracting the nodes ToNode of the link end point of a link group right before the intersection when the traffic lights information matched with the intersection is not present.

Thereafter, the caution zone data generation unit returns to step S220 or terminates the method of generating and extracting caution zone data in a path according to an embodiment of the present disclosure by determining a path end point (S280).

The method of generating caution zone data in a path according to an embodiment of the present disclosure has been described with reference to the flowcharts presented in the drawings. For a simple description, the method has been illustrated and described as a series of blocks, but the present disclosure is not limited to the sequence of the blocks, and some blocks may be performed in a sequence different from or simultaneously with that of other blocks, which has been illustrated and described in this specification. Various other branches, flow paths, and sequences of blocks which achieve the same similar results may be implemented. Furthermore, all the blocks illustrated in order to implement the method described in this specification may not be required.

Meanwhile, in the description given with reference to FIG. 8, each of the steps may be further divided into additional steps or the steps may be combined into smaller steps depending on an implementation example of the present disclosure. Furthermore, some of the steps may be omitted, if necessary, and the sequence of the steps may be changed. Furthermore, the contents of FIGS. 1 to 7, although some contents are omitted, may be applied to the contents of FIG. 8. Furthermore, the contents of FIG. 8 may be applied to the contents of FIGS. 1 to 7.

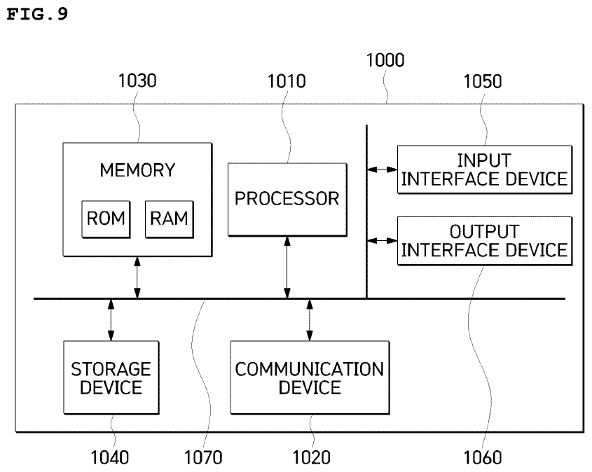

FIG. 9 is a block diagram illustrating a computer system for implementing a method of generating caution zone data in a path according to an embodiment of the present disclosure.

Referring to FIG. 9, a computer system 1000 may include at least one of a processor 1010, memory 1030, an input interface device 1050, an output interface device 1060, and a storage device 1040 which communicate with each other through a bus 1070. The computer system 1000 may further include a communication device 1020 connected to a network. The processor 1010 may be a central processing unit (CPU) or may be a semiconductor device that executes instructions stored in the memory 1030 or the storage device 1040. The memory 1030 and the storage device 1040 may each include various types of volatile or nonvolatile storage media. For example, the memory may include read-only memory (ROM) and random access memory (RAM). In an embodiment of the present specification, the memory may be disposed inside or outside the processor and connected to the processor through various known means. The memory includes various types of volatile or nonvolatile storage media, and may include ROM or RAM, for example.

Accordingly, an embodiment of the present disclosure may be implemented as a method implemented in a computer or may be implemented as a non-transitory computer-readable medium in which a computer-executable instruction has been stored. In an embodiment, when being executed by a processor, a computer-readable instruction may perform a method according to at least one aspect of this writing.

The communication device 1020 may transmit or receive a wired signal or a wireless signal.

Furthermore, the method according to an embodiment of the present disclosure may be implemented in the form of a program instruction which may be executed through various computer means, and may be recorded on a computer-readable medium.

The computer-readable medium may include a program instruction, a data file, and a data structure alone or in combination. A program instruction recorded on the computer-readable medium may be specially designed and constructed for an embodiment of the present disclosure or may be known and available to those skilled in the computer software field. The computer-readable medium may include a hardware device configured to store and execute the program instruction. For example, the computer-readable medium may include magnetic media such as a hard disk, a floppy disk, and a magnetic tape, optical media such as CD-ROM and a DVD, magneto-optical media such as a floptical disk, ROM, RAM, and flash memory. The program instruction may include not only a machine code produced by a compiler, but a high-level language code capable of being executed by a computer through an interpreter.

For reference, the components according to an embodiment of the present disclosure may be implemented in the form of software or hardware, such as a digital signal processor (DSP), a field programmable gate array (FPGA), or an application specific integrated circuit (ASIC), and may perform predetermined roles.

However, the “components” are not components having meanings limited to software or hardware, and each component may be configured to reside on an addressable storage medium and may be configured to operate one or more processors.

Accordingly, for example, the component may include components, such as software components, object-oriented software components, class components, and task components, processes, functions, attributes, procedures, sub-routines, segments of a program code, drivers, firmware, a microcode, circuitry, data, database, data structures, tables, arrays, and variables.

Components and functions provided in corresponding components may be combined into fewer components or may be further separated into additional components.

Meanwhile, it will be understood that each block of the flowcharts and combinations of the blocks in the flowcharts may be executed by computer program instructions. These computer program instructions may be mounted on the processor of a general purpose computer, a special purpose computer, or other programmable data processing equipment, so that the instructions executed by the processor of the computer or other programmable data processing equipment create means for executing the functions specified in the flowchart block(s). The computer program instructions may also be loaded on a computer or other programmable data processing equipment to cause a series of operational steps to be performed on the computer or other programmable data processing equipment to produce a computer-executed process, So that the instructions executing the computer or other programmable data processing equipment provide steps for executing the functions described in the flowchart block(s).

Furthermore, each block of the flowcharts may represent a portion of a module, a segment, or code, which includes one or more executable instructions for executing a specified logical function(s). It should also be noted that in some alternative implementations, the functions noted in the blocks may occur out of order. For example, two blocks shown in succession may in fact be executed substantially concurrently, or the blocks may sometimes be executed in the reverse order, depending upon the functionality involved.

The term “ . . . unit” or “ . . . module” used in the present embodiment means a software component or a hardware component, such as an FPGA or an ASIC, and the “ . . . unit” or “ . . . module” performs specific tasks. However, the term “ . . . unit” or “ . . . module” does not mean that it is limited to software or hardware. The “unit” or “ . . . module” may be configured to reside on an addressable storage medium and configured to operate one or more processors. Accordingly, examples of the “ . . . unit” or “ . . . module” may include components, such as software components, object-oriented software components, class components, and task components, processes, functions, attributes, procedures, sub-routines, segments of a program code, drivers, firmware, a microcode, circuitry, data, a database, data structures, tables, arrays, and variables. The functionalities provided in the components and the “ . . . units” or “ . . . modules” may be combined into fewer components and “ . . . units” or “ . . . modules” , or may be further separated into additional components and “ . . . units” or “ . . . modules”. Furthermore, the components and the “ . . . units” or “ . . . modules” may be implemented to operate one or more CPUs within a device or a security multimedia card.

Although the present disclosure has been described with reference to the preferred embodiments, those skilled in the art may understand that the present disclosure may be modified and changed in various ways without departing from the spirit and scope of the present disclosure written in the claims.

1. A system for generating caution zone data in a path, the system comprising:
a trajectory information generation unit configured to generate trajectory information comprising a link group including links that connect a plurality of nodes in a path up to a destination of an autonomous vehicle; and
a caution zone data generation unit configured to generate caution zone data by matching a link group of a zone that requires attention when the autonomous vehicle travels, among link groups included in the trajectory information.

2. The system of claim 1, wherein the caution zone data generation unit generates the caution zone data matched with a corresponding link group when a link group corresponding to an intersection is present in link groups included in the trajectory information.

3. The system of claim 2, wherein the caution zone data comprise one or more data, among estimated vehicle-joining section data, crosswalk data, traffic lights data, and stop line section data in which traffic lights are not present.

4. The system of claim 3, wherein the caution zone data generation unit searches for a link group that is connected to a link group in a direction to proceed after the intersection and generates estimated vehicle-joining section data based on node information of links belonging to the retrieved link group.

5. The system of claim 3, wherein the caution zone data generation unit generates crosswalk data by extracting crosswalk information matched with the intersection.

6. The system of claim 3, wherein the caution zone data generation unit generates traffic lights data by extracting traffic lights information matched with the intersection.

7. The system of claim 6, wherein the caution zone data generation unit generates stop line section data in which traffic lights are not present by extracting nodes ToNode of a link end point of a link group right before the intersection when traffic lights information matched with the intersection is not present.

8. A method of generating caution zone data in a path, comprising:
a trajectory information generation step of generating, by a trajectory information generation unit, trajectory information comprising a link group including links that connect a plurality of nodes in a path up to a destination of an autonomous vehicle; and
a caution zone data generation step of generating, by a caution zone data generation unit, caution zone data by matching a link group of a zone that requires attention when the autonomous vehicle travels, among link groups included in the trajectory information.

9. The method of claim 8, wherein the caution zone data generation step comprises a step of generating, by the caution zone data generation unit, caution zone data matched with a corresponding link group when the link group corresponding to an intersection is present in link groups included in the trajectory information.

10. The method of claim 9, wherein the caution zone data comprise one or more data, among estimated vehicle-joining section data, crosswalk data, traffic lights data, and stop line section data in which traffic lights are not present.
